(19) United States
(12) Patent Application Publication
(10) Pub. No.: US 2026/0046816 A1
(43) Pub. Date: Feb. 12, 2026

(54) METHOD AND APPARATUS FOR TRANSMITTING OR RECEIVING WIRELESS SIGNAL IN WIRELESS COMMUNICATION SYSTEM

(71) Applicant: LG ELECTRONICS INC., Seoul (KR)

(72) Inventors: Seunggye HWANG, Seoul (KR); Woosuk KO, Seoul (KR); Hanbyul SEO, Seoul (KR); Joongkwan HUH, Seoul (KR); Hyunsoo KO, Seoul (KR); Seungmin LEE, Seoul (KR)

(73) Assignee: LG ELECTRONICS INC., Seoul (KR)

(21) Appl. No.: 19/101,212

(22) PCT Filed: Aug. 8, 2023
(86) PCT No.: PCT/KR2023/011640

§ 371 Date: Feb. 4, 2025

(30) Foreign Application Priority Data
Aug. 11, 2022 (KR) 10-2022-0100804

(51) Int. Cl. H04W 64/00; H04L 5/00

(52) U.S. Cl. CPC H04W 64/00; H04L 5/0051

(57) ABSTRACT

A method performed by a first device may comprise: receiving configuration information about a reference signal of a first type related to positioning; transmitting, a plurality of times, the reference signal in a time interval including a plurality of first time resources; and receiving, from the second device, a reference signal of a second type related to the positioning in one second time resource located after the time interval including the plurality of first time resources.

### TECHNICAL FIELD

The present disclosure relates to a wireless communication system, and more particularly, to a method and apparatus for transmitting and receiving a wireless signal.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the present disclosure is to provide a method of efficiently performing wireless signal transmission/reception procedures and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

According to an aspect, a method of transmitting a signal by a first device in a wireless communication system includes receiving configuration information for a first type of reference signal related to positioning, transmitting the first type of reference signal to a second device multiple times based on the configuration information in a time duration including a plurality of first time resources, and receiving, from the second device, a second type of reference signal related to positioning in one second time resource located after the time duration including the plurality of first time resources. The reception of the second type of reference signal that is performed on the one second time resource, may be related to the multiple times of transmissions of the first type of reference signal. The time duration including the plurality of first time resources may be determined based on the repetition number for the first type of reference signal included in the configuration information.

The multiple transmissions of the first type of reference signal and receptions of the second type of reference signal may be related to round trip time (RTT) measurement.

Reception of the one second type of reference signal, performed on the one second time resource, may be related to a plurality of RTT measurement values based on the same reception timing (Rx timing). The first device may transmit a measurement report including the plurality of RTT measurement values. The measurement report may further include information about a time interval between the plurality of first time resources.

The plurality of first time resources may be spaced apart from each other in the time domain based on the time interval.

Information about the time interval may be obtained through measurement configuration related to positioning.

The first type of reference signal may be a sounding reference signal (SRS) for positioning. The first device may be a user equipment (UE).

The second type of reference signal may be a positioning reference signal (PRS), and the second device may be at least one BS or at least one transmission and reception point (TRP).

According to an aspect, a computer-readable recording medium having recorded thereon a program for performing the signal transmission method described above may be provided.

According to an aspect, a first device for wireless communication for performing the signal transmission method described above may be provided.

According to an aspect, a method of receiving a signal from a first device by a second device in a wireless communication system includes transmitting, to the first device, configuration information for a first type of reference signal related to positioning, receiving, from the first device, the first type of reference signal multiple times based on the configuration information in a time duration including a plurality of first time resources, and transmitting, to the first device, a second type of reference signal related to positioning in one second time resource located after the time duration including the plurality of first time resources. Transmission of the second type of reference signal, performed on the one second time resource, may be related to the multiple times of receptions of the first type of reference signal. The time duration including the plurality of first time resources may be determined based on the repetition number for the first type of reference signal provided in the configuration information.

According to an aspect, a second device for wireless communication for performing the signal reception method described above may be provided.

### Advantageous Effects

According to an embodiment of the present disclosure, wireless signal transmission/reception procedures may be performed accurately and efficiently.

It will be appreciated by persons skilled in the art that the effects that may be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates exemplary mapping of physical channels in a slot. FIG. 1 illustrates physical channels used in a 3rd generation partnership project (3GPP) system as an exemplary wireless communication system, and a general signal transmission method using the same.

FIG. 2 illustrates a radio frame structure.

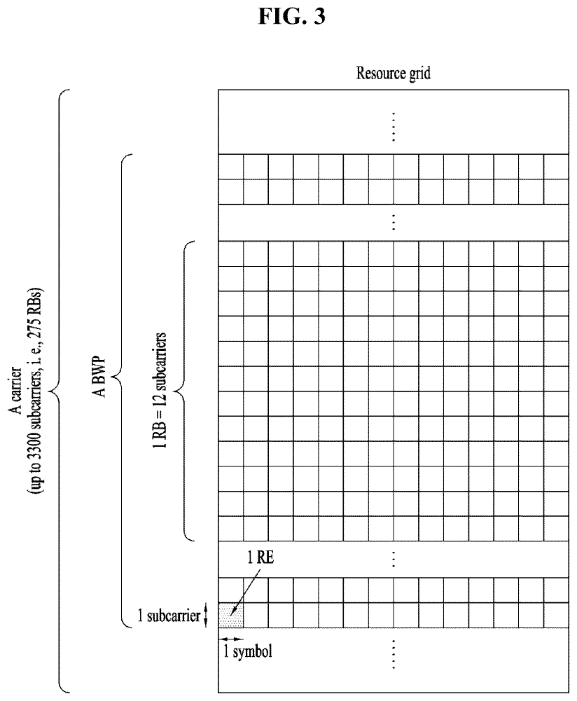

FIG. 3 illustrates a resource grid of a slot.

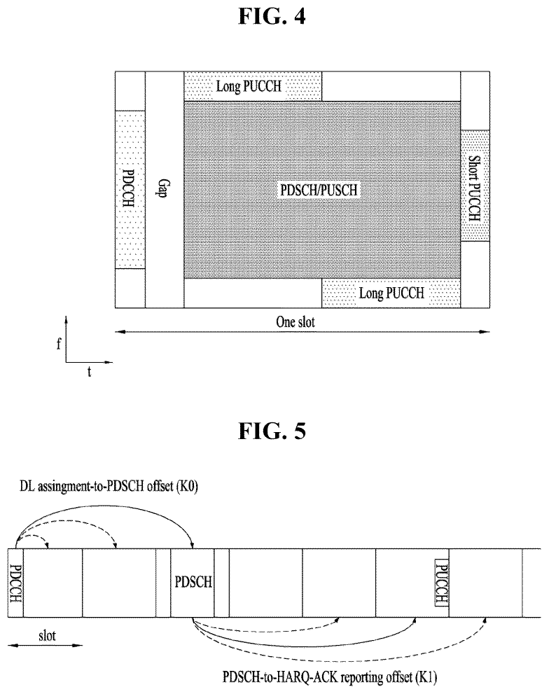

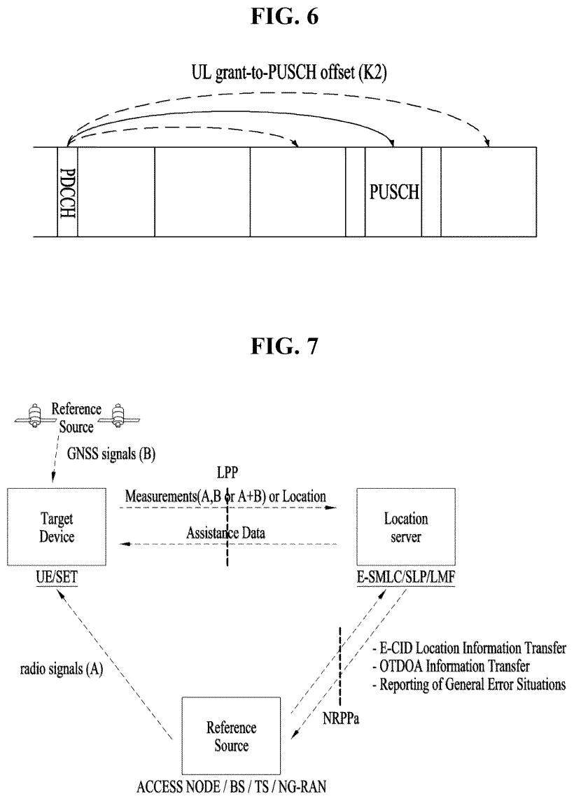

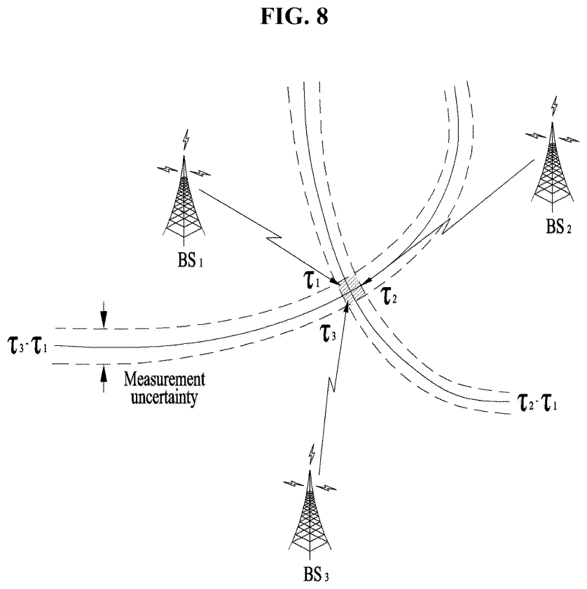

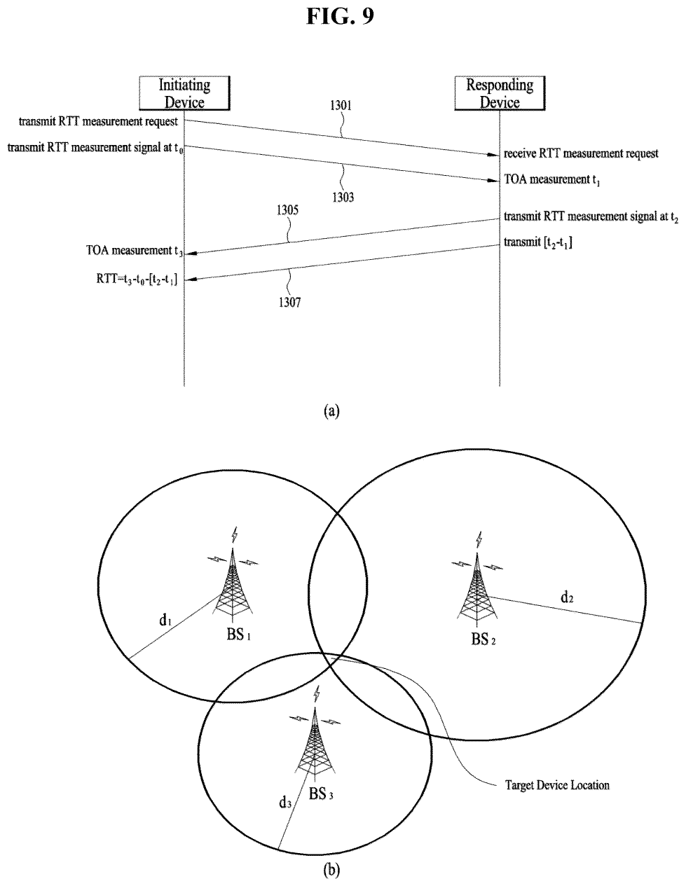

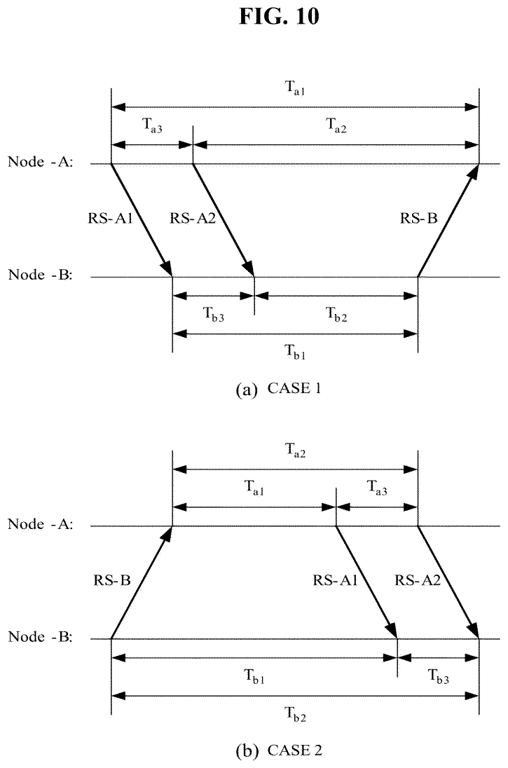

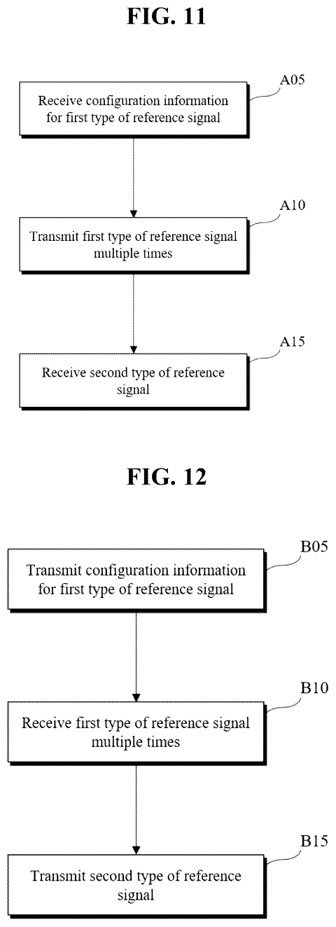

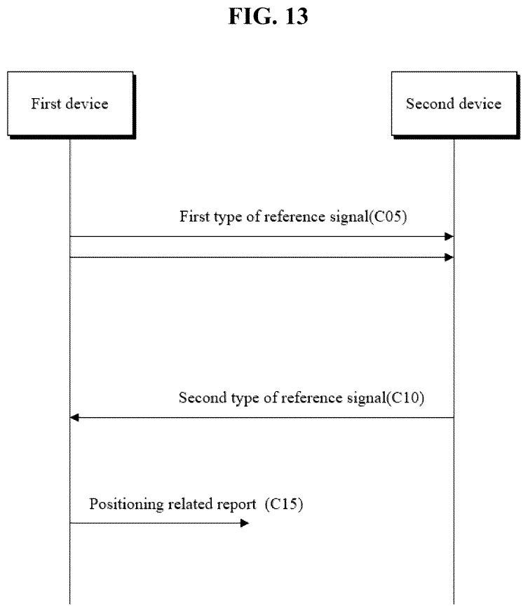

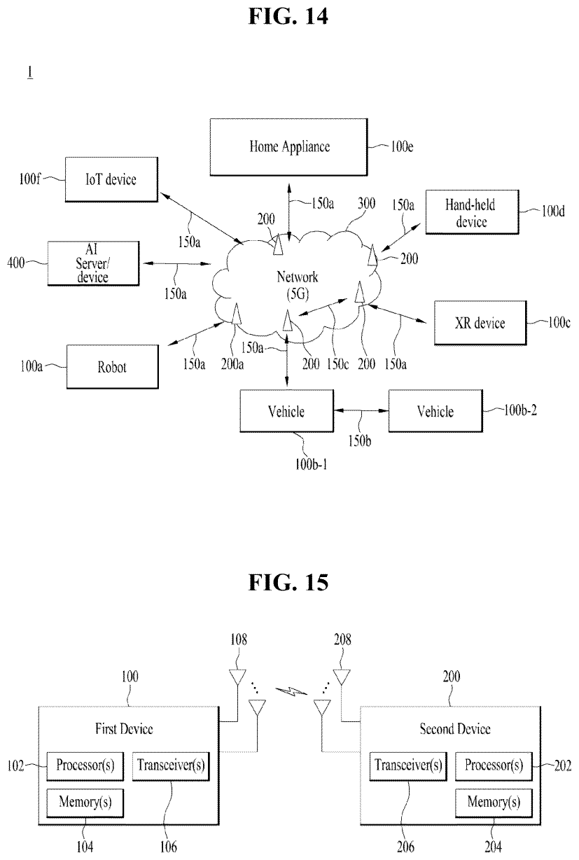

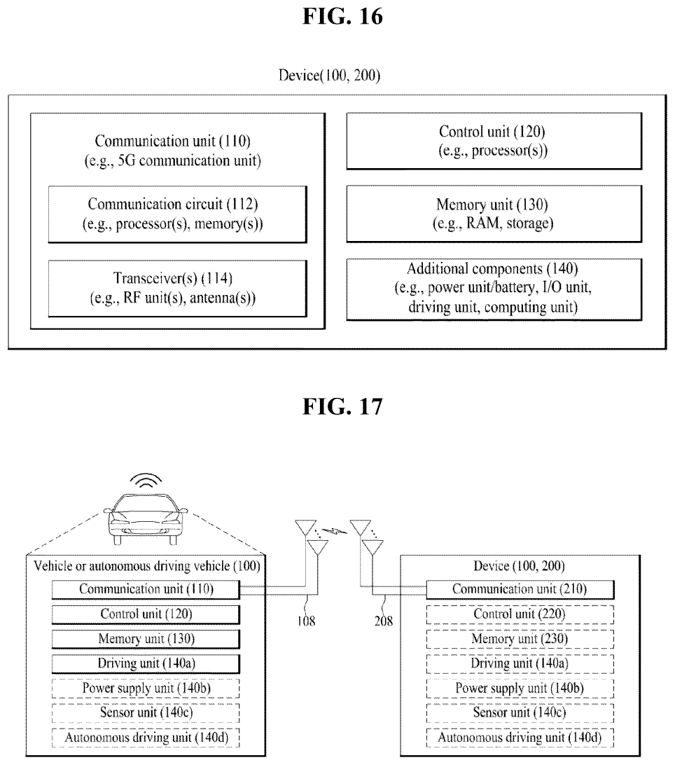

FIG. 4 illustrates exemplary mapping of physical channels in a slot

FIG. 5 illustrates an exemplary physical downlink shared channel (PDSCH) reception and acknowledgement/negative acknowledgement (ACK/NACK) transmission process.

FIG. 6 illustrates an exemplary physical uplink shared channel (PUSCH) transmission process.

FIG. 7 illustrates an example of setting a positioning protocol.

FIG. 8 illustrates an example of OTDOA.

FIG. 9 illustrates an example of Multi RTT.

FIG. 10 illustrates examples of a nested RTT according to an embodiment.

FIG. 11 is a diagram for explaining an operation of a first device for a nested RTT according to an embodiment.

FIG. 12 is a diagram for explaining an operation of a second device for a nested RTT according to an embodiment.

FIG. 13 is a diagram for explaining operations of devices in a network system for a nested RTT according to an embodiment.

FIGS. 14 to 17 illustrate an example of a communication system 1 and wireless devices applicable to the present disclosure.

### DETAILED DESCRIPTION

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In an embodiment of the present disclosure, for simplicity, this technology will be referred to as NR (New Radio or New RAT).

For the sake of clarity, 3GPP NR is mainly described, but the technical idea of the present disclosure is not limited thereto.

For the background art relevant to the present disclosure, the definitions of terms, and abbreviations, the following documents may be incorporated by reference.
38.211: Physical channels and modulation
38.212: Multiplexing and channel coding
38.213: Physical layer procedures for control
38.214: Physical layer procedures for data
38.215: Physical layer measurements
38.300: NR and NG-RAN Overall Description
38.304: User Equipment (UE) procedures in idle mode and in RRC Inactive state
38.321 Medium Access Control (MAC) protocol specification
38.331: Radio Resource Control (RRC) protocol specification
37.213: Introduction of channel access procedures to unlicensed spectrum for

### NR-Based Access

36.355: LTE Positioning Protocol
37.355: LTE Positioning Protocol

### Terms and Abbreviations

5GC: 5G Core Network
5GS: 5G System
AoA: Angle of Arrival
AP: Access Point
CID: Cell ID
E-CID: Enhanced Cell ID
GNSS: Global Navigation Satellite System
GPS: Global Positioning System
LCS: LoCation Service
LMF: Location Management Function
LPP: LTE Positioning Protocol
MO-LR: Mobile Originated Location Request
MT-LR: Mobile Terminated Location Request
NRPPa: NR Positioning Protocol A
OTDOA: Observed Time Difference Of Arrival
PDU: Protocol Data Unit
PRS: Positioning Reference Signal
RRM: Radio Resource Management
RSSI: Received Signal Strength Indicator
RSTD: Reference Signal Time Difference
ToA: Time of Arrival
TP: Transmission Point
TRP: Transmission and Reception Point
UE: User Equipment
SS: Search Space
CSS: Common Search Space
USS: UE-specific Search Space
PDCCH: Physical Downlink Control Channel
PDSCH: Physical Downlink Shared Channel;
PUCCH: Physical Uplink Control Channel;
PUSCH: Physical Uplink Shared Channel;
DCI: Downlink Control Information
UCI: Uplink Control Information
SI: System Information
SIB: System Information Block
MIB: Master Information Block
RRC: Radio Resource Control
DRX: Discontinuous Reception
RNTI: Radio Network Temporary Identifier
CSI: Channel state information
PCell: Primary Cell
SCell: Secondary Cell
PSCell: Primary SCG (Secondary Cell Group) Cell
CA: Carrier Aggregation
WUS: Wake up Signal
TX: Transmitter
RX: Receiver

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

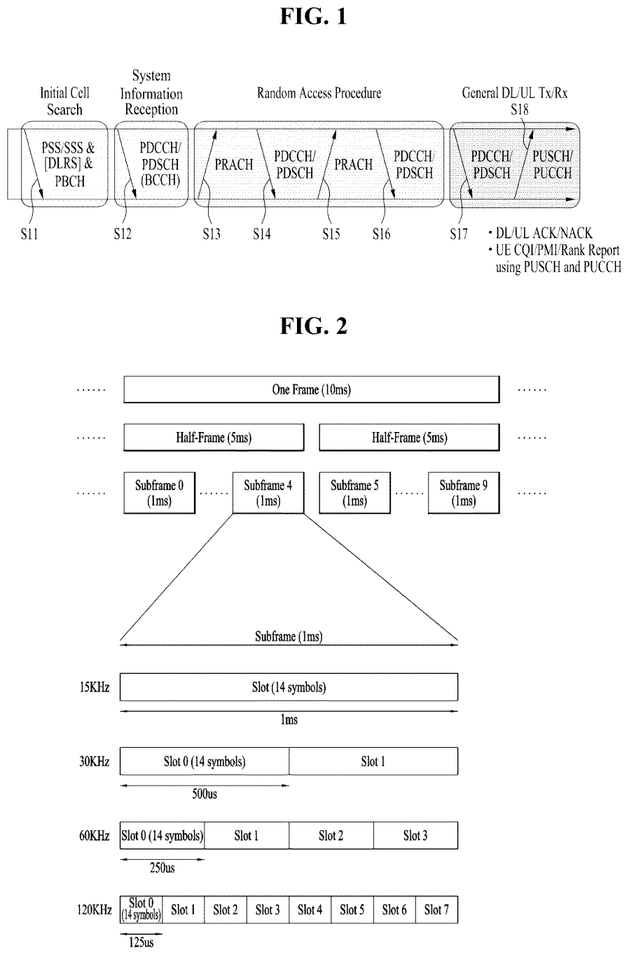

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: Number of symbols in a slot
* N^{frame, u}ₛₗₒₜ: Number of slots in a frame
* N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

FIG. 4 illustrates an example of mapping physical channels in a slot. In an NR system, a frame is characterized by a self-contained structure in which all of a DL control channel, DL or UL data, and a UL channel may be included in one slot. For example, the first N symbols of a slot may be used to carry a DL channel (e.g., PDCCH) (hereinafter, referred to as a DL control region), and the last M symbols of the slot may be used to carry a UL channel (e.g., PUCCH) (hereinafter, referred to as a UL control region). Each of N and M is an integer equal to or larger than 0. A resource area (hereinafter, referred to as a data region) between the DL control region and the UL control region may be used to transmit DL data (e.g., PDSCH) or UL data (e.g., PUSCH). A guard period (GP) provides a time gap for switching from a transmission mode to a reception mode or from the reception mode to the transmission mode. Some symbols at a DL-to-UL switching time in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

FIG. 5 illustrates an exemplary PDSCH reception and ACK/NACK transmission process. Referring to FIG. 5, the UE may detect a PDCCH in slot #n. The PDCCH includes DL scheduling information (e.g., DCI format 1_0 or DCI format 1_1), and indicates a DL assignment-to-PDSCH offset, K0 and a PDSCH-HARQ-ACK reporting offset, K1. After receiving a PDSCH in slot #(n+K0) according to the scheduling information of slot #n, the UE may transmit UCI on a PUCCH in slot #(n+K1). The UCI may include an HARQ-ACK response to the PDSCH. In the case where the PDSCH is configured to carry one TB at maximum, the HARQ-ACK response may be configured in one bit. In the case where the PDSCH is configured to carry up to two TBs, the HARQ-ACK response may be configured in 2 bits if spatial bundling is not configured and in 1 bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

FIG. 6 illustrates an exemplary PUSCH transmission procedure. Referring to FIG. 6, the UE may detect a PDCCH in slot #n. The PDCCH includes DL scheduling information (e.g., DCI format 1_0 or 1_1). The UE may then transmit a PUSCH in slot #(n+K2) according to the scheduling information in slot #n. The PUSCH includes a UL-SCH TB.

### Positioning

Positioning may refer to determining the geographical position and/or velocity of the UE based on measurement of radio signals. Location information may be requested by and reported to a client (e.g., an application) associated with to the UE. The location information may also be requested by a client within or connected to a core network. The location information may be reported in standard formats such as formats for cell-based or geographical coordinates, together with estimated errors of the position and velocity of the UE and/or a positioning method used for positioning.

FIG. 7 is a diagram illustrating an exemplary positioning protocol configuration for positioning a UE, to which various embodiments are applicable.

Referring to FIG. 7, an LTE positioning protocol (LPP) may be used as a point-to-point protocol between a location server (E-SMLC and/or SLP and/or LMF) and a target device (UE and/or SET), for positioning the target device using position-related measurements obtained from one or more reference resources. The target device and the location server may exchange measurements and/or location information based on signal A and/or signal B over the LPP.

NRPPa may be used for information exchange between a reference source (access node and/or BS and/or TP and/or NG-RAN node) and the location server.

The NRPPa protocol may provide the following functions.
E-CID Location Information Transfer. This function allows the reference source to exchange location information with the LMF for the purpose of E-CID positioning.
OTDOA Information Transfer. This function allows the reference source to exchange information with the LMF for the purpose of OTDOA positioning.
Reporting of General Error Situations. This function allows reporting of general error situations, for which function-specific error messages have not been defined.

Positioning methods supported in the NG-RAN may include a GNSS, an OTDOA, an E-CID, barometric sensor positioning, WLAN positioning, Bluetooth positioning, a TBS, uplink time difference of arrival (UTDOA) etc. Although any one of the positioning methods may be used for UE positioning, two or more positioning methods may be used for UE positioning.

### OTDOA (Observed Time Difference of Arrival)

FIG. 8 is a diagram illustrating an observed time difference of arrival (OTDOA) positioning method, to which various embodiments are applicable;

The OTDOA positioning method uses time measured for DL signals received from multiple TPs including an eNB, an ng-eNB, and a PRS-only TP by the UE. The UE measures time of received DL signals using location assistance data received from a location server. The position of the UE may be determined based on such a measurement result and geographical coordinates of neighboring TPs.

The UE connected to the gNB may request measurement gaps to perform OTDOA measurement from a TP. If the UE is not aware of an SFN of at least one TP in OTDOA assistance data, the UE may use autonomous gaps to obtain an SFN of an OTDOA reference cell prior to requesting measurement gaps for performing reference signal time difference (RSTD) measurement.

Here, the RSTD may be defined as the smallest relative time difference between two subframe boundaries received from a reference cell and a measurement cell. That is, the RSTD may be calculated as the relative time difference between the start time of a subframe received from the measurement cell and the start time of a subframe from the reference cell that is closest to the subframe received from the measurement cell. The reference cell may be selected by the UE.

For accurate OTDOA measurement, it is necessary to measure time of arrival (ToA) of signals received from geographically distributed three or more TPs or BSs. For example, ToA for each of TP 1, TP 2, and TP 3 may be measured, and RSTD for TP 1 and TP 2, RSTD for TP 2 and TP 3, and RSTD for TP 3 and TP 1 are calculated based on three ToA values. A geometric hyperbola is determined based on the calculated RSTD values and a point at which curves of the hyperbola cross may be estimated as the position of the UE. In this case, accuracy and/or uncertainty for each ToA measurement may occur and the estimated position of the UE may be known as a specific range according to measurement uncertainty.

For example, RSTD for two TPs may be calculated based on Equation 1 below.

$$RSTDi , 1 \frac{- \sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} {( {y}_{t} - {y}_{1} )}^{2}}}{c} + ( {T}_{i} - {T}_{1} ) + ( {n}_{i} - {n}_{1} ) \qquad [ Equation 1 ]$$

In Equation 1, c is the speed of light, {xₜ, yₜ} are (unknown) coordinates of a target UE, {xᵢ, yᵢ} are (known) coordinates of a TP, and {x₁, y₁} are coordinates of a reference TP (or another TP). Here, (Tᵢ−T₁) is a transmission time offset between two TPs, referred to as “real time differences” (RTDs), and nᵢ and n₁ are UE ToA measurement error values.

### E-CID (Enhanced Cell ID)

In a cell ID (CID) positioning method, the position of the UE may be measured based on geographical information of a serving ng-eNB, a serving gNB, and/or a serving cell of the UE. For example, the geographical information of the serving ng-eNB, the serving gNB, and/or the serving cell may be acquired by paging, registration, etc.

The E-CID positioning method may use additional UE measurement and/or NG-RAN radio resources in order to improve UE location estimation in addition to the CID positioning method. Although the E-CID positioning method partially may utilize the same measurement methods as a measurement control system on an RRC protocol, additional measurement only for UE location measurement is not generally performed. In other words, an additional measurement configuration or measurement control message may not be provided for UE location measurement. The UE does not expect that an additional measurement operation only for location measurement will be requested and the UE may report a measurement value obtained by generally measurable methods.

For example, the serving gNB may implement the E-CID positioning method using an E-UTRA measurement value provided by the UE.

Measurement elements usable for E-CID positioning may be, for example, as follows.

UE measurement: E-UTRA reference signal received power (RSRP), E-UTRA reference signal received quality (RSRQ), UE E-UTRA reception (Rx)-transmission (Tx) time difference, GERAN/WLAN reference signal strength indication (RSSI), UTRAN common pilot channel (CPICH) received signal code power (RSCP), and/or UTRAN CPICH Ec/Io

E-UTRAN measurement: ng-eNB Rx-Tx time difference, timing advance (T_{ADV}), and/or AoA

Here, T_{ADV} may be divided into Type 1 and Type 2 as follows.

T_{ADV} Type 1=(ng-eNB Rx-Tx time difference)+(UE E-UTRA Rx-Tx time difference)

T_{ADV} Type 2=ng-eNB Rx-Tx time difference

AoA may be used to measure the direction of the UE. AoA is defined as the estimated angle of the UE counterclockwise from the eNB/TP. In this case, a geographical reference direction may be north. The eNB/TP may use a UL signal such as an SRS and/or a DMRS for AoA measurement. The accuracy of measurement of AoA increases as the arrangement of an antenna array increases. When antenna arrays are arranged at the same interval, signals received at adjacent antenna elements may have constant phase rotate.

### UTDOA (Uplink Time Difference of Arrival)

UTDOA is a method of determining the location of a UE by estimating the arrival time of the SRS. When calculating the estimated SRS arrival time, the location of the UE may be estimated through an arrival time difference with another cell (or base station/TP) by using the serving cell as a reference cell. To implement UTDOA, the E-SMLC may indicate a serving cell of the target UE in order to instruct the target UE to transmit SRS. In addition, E-SMLC may provide configuration such as periodic/aperiodic SRS, bandwidth and frequency/group/sequence hopping.

### Multi RTT (Round Trip Time)

FIG. 9 is a diagram illustrating an exemplary multi-round trip time (multi-RTT) positioning method to which various embodiments are applicable.

Referring to FIG. 9(a), an exemplary RTT procedure is illustrated, in which an initiating device and a responding device perform ToA measurements, and the responding device provides ToA measurements to the initiating device, for RTT measurement (calculation). The initiating device may be a TRP and/or a UE, and the responding device may be a UE and/or a TRP.

The initiating device may transmit an RTT measurement request, and the responding device may receive the RTT measurement request (1301).

The initiating device may transmit an RTT measurement signal at to and the responding device may acquire a ToA measurement t1 (1303).

The responding device may transmit an RTT measurement signal at t2 and the initiating device may acquire a ToA measurement t3 (1305).

The responding device may transmit information about [t2−t1], and the initiating device may receive the information and calculate an RTT by Equation 2 (1307). The information may be transmitted and received based on a separate signal or in the RTT measurement signal (1305).

$$RTT = {t}_{3} - {t}_{0} = [ {t}_{2} - {t}_{1} ] \qquad [ Equation 2 ]$$

Referring to FIG. 9(b), an RTT may correspond to a double-range measurement between two devices. Positioning estimation may be performed from the corresponding information, and multilateration may be used for the positioning estimation. d₁, d₂, and d₃ may be determined based on the measured RTT, and the location of a target device may be determined to be the intersection of the circumferences of circles with radiuses of d₁, d₂, and d₃, in which BS₁, BS₂, and BS₃ (or TRPs) are centered, respectively.

### Nested RTT Positioning

As described above, various positioning schemes are used in the 3GPP NR. Multi RTT in the 3GPP NR is a positioning scheme by which a BS and a UE measure/report a difference (i.e. RX-TX time difference) between reception and transmission times of a positioning reference signal (PRS) and a surrounding reference signal (SRS) and uses an RS propagation delay obtained therefrom. The multi RTT has an advantage of being robust to synchronization degradation between TX ends compared to other positioning schemes, but has a disadvantage of requiring relatively many RS resources and low resource efficiency because both PRS and SRS transmissions from the BS and the UE are required.

In the 3GPP NR standard, various methods have been discussed to support positioning schemes in sidelink (SL) transmission and reception environments. In the case of an SL environment, occurrence of clock errors may be significant depending on a method of determining the synchronization source, unlike in general communication between a BS and a UE. According to the 3GPP TS 38.101 standard, when NR V2X SL UEs use the same synchronization source, a clock error between the two UEs satisfies a condition of within ±0.1 ppm, but when synchronization sources are not the same, the clock error between the two UEs may exceed ±0.1 ppm. If a clock error occurs between two SL UEs, this may cause a difference in an estimation value of the Rx-TX time difference, thereby degrading the performance of multi-RTT.

A carrier phase measurement (CPM)-based positioning method in the 3GPP NR standard to provide cm-level positioning precision has been discussed as a method of positioning enhancement. The CPM has been mainly considered as a method of taking measurement within a wavelength of a carrier frequency used when transmitting and receiving a PRS and a SRS. Considering that the CPM is a scheme that requires high precision, an influence of error sources that may occur between a BS and a UE needs to be analyzed more precisely than other existing positioning schemes, and methods to overcome this need to be considered. From this perspective, a method of reducing the influence of a synchronization error between nodes by additionally applying multi-RTT to CPM-based positioning, but even in this case, there is a problem that the clock error described above may affect CPM.

To resolve such problem, the specification proposes a new nested RTT structure and also proposes an operation of nodes (e.g., BS//TRP and UE) required for the nested RTT and the configuration of information transmitted and received. The proposed method may have an advantageous effect of significantly reducing the influence of a clock error between two nodes (e.g., BS and UE, or two SL UEs) on RTT-based positioning accuracy. The proposed method may have an advantage in that most of the existing positioning method and PRS/SRS transmission/reception procedures may be shared because improved transmission/reception methods and reporting operations are considered based on the basic structure of the existing multi-RTT.

Hereinafter, the description focuses on a BS and UEs that perform positioning based on a 3GPP NR system, but is not limited thereto. For example, two or more nodes that transmit and receive reference signals for positioning purposes may be present and may be applied to other communication systems that have a structure that measures and utilizes a RX-TX time difference. One or more of the following methods may be applied in combination. Some terms, symbols, and sequences used may be replaced by other terms, symbols, and sequences. For example, the term nested RTT may be replaced by double side RTT.

The structure of the nested RTT may comply with the basic structure of RTT in which two nodes transmit and receive reference signals (hereinafter referred to as RS) and perform positioning by measuring the RX-TX time difference through the transmitted and received RSs. In the specification, for the convenience of explanation, a method in which a nested RTT operates between two nodes forming a pair and a distance between the two nodes is proposed, but the proposed method may also be applied and used in a structure of multiple nested RTT in which one node performs positioning by performing nested RTT for two or more nodes.

For convenience, the two nodes are defined and described as Node-A and Node-B in the specification. In this case, the Node-A is a node that transmits a reference signal burst (hereinafter referred to as RS burst) including at least two RSs at a promised time for the purpose of nested RTT, and the Node-B may expect that the Node-A transmits an RS burst at the promised time and perform a reception operation of at least two RSs within the RS burst. The Node-B is a node that transmits at least one RS(s) at another promised time for the purpose of nested RTT, and the node-B may perform a reception operation for at least one RS, expecting that the node-A transmits RS(s) at the another promised time.

For example, when the structure of the nested RTT is applied to Uu positioning based on 3GPPP NR, the Node-A may be either a BS or a UE, and when the Node-A is a BS, the RS burst the BS transmits may include PRSs transmitted by the BS, and when the Node-A is a UE, the RS burst the UE transmits may include SRSs transmitted by the UE. The Node-B may be a BS or a UE, and when the Node-B is a BS, the RS transmitted may be a PRS transmitted by the BS, and when the Node-B is a UE, the RS transmitted may be an SRS transmitted by the UE. In this case, a resource configuration and promised transmission/reception time of the PRS may be information provided/instructed to the UE through LPP by the LMF, and the resource configuration and promised transmission/reception time of the SRS may be information provided/instructed to the UE through RRC/MAC/DCI, or the like transmitted by the BS. The BS may also be represented by a TRP.

For example, when the structure of the nested RTT is applied to SL positioning, the node-A and the node-B may each be UEs performing an SL function. In this case, the RS burst and RS transmitted by each node may be SL PRS or SL SRS.

FIG. 10 shows two examples of performing nested RTT between a node-A and a node-B. Referring to FIG. 10, an RS burst may include multiple RS transmissions, for example, the multiple RS transmissions may be (at least) two. Multiple RS transmissions may be performed on different time resources in the time domain, and at least some of the different time resources may be spaced apart from each other. There may be a gap of at least one symbol between time resources, as described below.
CASE 1 shows a structure in which the node-A transmits the RS burst (RS-A1 or RS-A2) first, and then the node-B receives the transmitted RS burst and then transmits RS (RS-B), which is then received by the node-A.
CASE 2 shows an order in which the RS transmitted by the node-B (RS-B) is transmitted first, then the node-A receives the transmitted RS and transmits an RS burst (RS-A1 or RS-A2), and the node-B receives the RS burst.

For example, when RSs belonging to the RS burst are expressed as RS-Ax, in Case 1, transmission of RS-Ax may be performed before RS-B, and in Case 2, transmission of RS-Ax may be performed after transmission of RS-B.

### Configuration of RS Burst

To support the nested RTT, a method of configuring RS bursts and selecting two or more RSs (e.g., RS-Ax in Case 1/2 of FIG. 10) within an RS burst is proposed.

For example, the configuration of the RS burst may be defined by utilizing a duration of positioning measurement GAP (PMG). In this case, the PMG refers to a duration of a measurement gap configured for the UE to obtain positioning measurement based on the 3GPP NR standard.

Hereinafter, the proposed methods are explained mainly for the case in which an RS burst is configured using the PMG and the RSs provided in the RS burst are PRSs, but even in other cases, even when a time duration configured for the purpose of providing a duration in which positioning measurement is possible for a specific node is used, the proposed methods may be generally applied, and those skilled in the art will understand that the RSs used are not limited to PRSs. For example, the proposed method may be applied to the configuration of the RS burst by using a concept of a positioning processing window introduced in the 3GPP NR Rel-17 standard. A specific method may be used by selecting one of the options below, or two or more may be used in combination.

(Option 1-1) Method of Determining Positioning Measurement GAP with RS Burst

When the node-A is a node transmitting a PRS, a duration of a PMG configured by an LMF may be determined as a duration of an RS burst as one method of configuring the RS burst by utilizing the PMG. In this case, the UE may determine to calculate a reception time of a PRS through at least two time points (hereinafter, time-1 and time-2) within the PMG. In this case, time-1 and time-2 may be determined to be selected under a condition that the minimum gap interval is ensured. The (minimum) size of the gap may use a predetermined value. For example, the gap may be at least 1 symbol or more. An example of the gap may be an interval of 1 ms (or 1 slot). Alternatively, the size of the gap may be a value indicated by the LMF, and information about the size of the gap may be provided to the UE by the LMF through an LPP through which the configuration information for the structure of the nested RTT is transmitted or through the LPP through which instruction information for indicating an operation of the nested RTT is transmitted. And/or, the size of the gap may be determined such that the UE selects a value greater than or equal to the minimum size of the gap under a condition that the minimum size of the gap is satisfied. In this case, the size of the gap may be configured within a range that allows the UE to select two or more RSs within the PMG and use the RSs for the measurement purpose of the nested RTT.

The configuration of the PMG for the nested RTT may be determined to share the configuration of the PMG used for other positioning methods. This has an advantage of being able to configure an RS burst without incurring separate signaling overhead.

The configuration of the PMG for the nested RTT may be configured independently from the configuration of the PMG used for other positioning methods. In this case, the UE may determine the position and length of the PMG differently according to the indicated positioning method, and when the operation of the nested RTT is indicated, it may be determined to expect an RS burst by using the PMG for the purpose of the nested RTT. For example, the configuration information of the PMG for the nested RTT purposes may include gap size information to be applied separately from the PMG for other positioning methods. Considering that a longer PMG may be required compared to other positioning methods because UEs supporting the nested RTT need to acquire at least two measurements with different time points, it may be expected to have an advantageous effect in that an adaptive PMG size suitable for the situation is provided.

The proposed method has an advantage in that PMG-related operations of UEs may be unified by configuring an RS burst by reusing the definition and configuration of the PMG to be shared with other positioning methods.

### (Option 1-2) RS Burst Configuration Method Using Multiple Positioning Measurement GAPs

When the node-A is a node transmitting a PRS, one RS burst including two or more PMGs configured by an LMF may be considered as another method of configuring an RS burst by utilizing the PMG. In this case, the UE may determine to calculate a reception time of the PRS for each PMG that constitutes one RS burst. For example, when an RS burst includes two PMGs, the UE may determine that a time point of the time-1 is calculated from a preceding PMG and a time point of the time-2 is calculated from another PMG.

Multiple PMGs that constitute an RS burst may be configured to different positioning methods and share configuration of the PMGs used. To this end, the LMF may determine the targets of PMGs provided in the RS burst and provide configuration information about the PMGs to the BS and the UE. For example, the configuration information may include configuration information (e.g. parameters such as periodicity and/or offset) regarding a reference point in time at which the RS burst starts. Information about a reference point in time at which the RS burst ends (e.g. the length of the RS burst) or the number of PMGs provided in the RS burst may be provided in the configuration information. This has an advantage of reducing overhead waste for configuration by sharing PMG configuration for other positioning methods and unifying UE operations for utilizing a PMG.

Multiple PMGs that constitute an RS burst may be configured to have a form in which the PMGs are repeated in a burst-like manner periodically. In this case, the periodic characteristics may be reused as a periodicity parameter used for configuring the PMG of another positioning method, or a periodicity parameter configured separately for the nested RTT may be defined and used. As a detailed method, a structure may be considered in which the locations of the PMG, which are determined based on a parameter that imparts the periodicity (e.g., a parameter of periodicity), may be configured as a starting PMG location of the RS burst, and N PMGs may be repeatedly generated at specific intervals from the location of the starting PMG. In this case, the specific interval and the size of N may be considered to be values that are predetermined by the standard (e.g., a structure in which one additional PMG is generated by being connected to the starting PMG (or with a certain gap)) or to be configured by the LMF and provided as configuration information to the BS and the UE. This may be advantageous in reducing a waiting time for the UE to complete an operation of the nested RTT by maintaining and ensuring an interval between the time-1 and the time-2 while reducing the interval to support an efficient operation of the nested RTT.

The proposed method has an advantage of clearly distinguishing between two or more different time points constructed on an RS burst, while allowing reuse of the existing PMG definition and configuration.

A method of constructing repetition transmission of an SRS may be considered as another method of configuring an RS burst. In this case, the SRS refers to a reference signal transmitted from a UE to a BS based on the 3GPP NR standard, and the SRS used specifically for positioning purposes is considered. In the following description, pos-SRS is described as a term that stands for a positioning SRS. Hereinafter, the present disclosure describes proposed methods considering a case in which an RS burst is configured using pos-SRS repetition transmission. However, those skilled in the art will understand that the proposed method may be generally applied even in cases other than these, in which the nested RTT is supported by using other reference signals for positioning purposes transmitted by BSs or UEs. As a detailed method, the following options may be selected and used.

### (Option 2-1) RS Burst Configuration Method Using Pos-SRS Repetition Transmission

According to the current NR standard, SRS repetition transmission may be defined to be performed through SRS configuration, but SRS repetition is not used for configuration of an SRS for positioning purposes (hereinafter, pos-SRS).

According to an embodiment of the present specification, SRS repetition transmission may also be applied to pos-SRS configuration for the nested RTT, and specifically, when a node-A is a node transmitting a pos-SRS, an RS burst may be configured as a unit of repetition of the pos-SRS. To indicate repetition of the pos-SRS, the configuration information of the pos-SRS may include a repetition factor parameter. If the configuration information of the pos-SRS includes a repetition factor and two or more repetitions are configured, and the operation of the nested RTT is instructed by the instruction information, the node-A may repeatedly transmit the pos-SRS according to the repetition factor information, and the node-B may repeatedly receive the pos-SRS according to the repetition factor information. Such repeated pos-SRSs may correspond to the RS-Ax illustrated in FIG. 10.

On the other hand, even if the repetition factor is provided in the configuration information of pos-SRS and repetitions are configured twice or more, when a positioning method other than a nested RTT is indicated by the instruction information, it may be determined not to perform repetition transmission of a pos-SRS or not to follow the repetition transmission structure of the pos-SRS for the nested RTT. This may be suitable for the purpose of sharing the configuration information of a pos-SRS with other positioning methods that do not require repetition transmission of the pos-SRS, while preventing unnecessary repetition transmission of the pos-SRS.

In the form in which repetition transmission of the pos-SRS is configured, a certain time gap may be configured between the repeatedly transmitted pos-SRS. For example, when an RS burst is configured with two repetition transmissions of the pos-SRS, a transmission/reception point of a first pos-SRS in the RS burst is a time-1 and a transmission/reception point of a second pos-SRS is a time-2, a time gap of a specific size may be configured between the time-1 and the time-2, and the location of the time-2 may be determined by offsetting the size of the time gap with respect to the time-1. In this case, the size of the time gap may be defined according to the standard, or determined by an LMF or a BS and provided to a node-A through configuration information or instruction information. For example, the size of the time gap may be expressed in units of ms or sub-ms, or may be information expressed in units of transmission units such as symbols or slots. The time gap configured between repeatedly transmitted pos-SRS may be related to Tb3 as shown in FIG. 10.

The proposed method has an advantage of supporting a UE transmitting a pos-SRS to function as the node-A by defining repetition transmission of the pos-SRS configured on a RS burst, while reusing the definition and configuration of the existing pos-SRS.

### Measurement of Distance Between Node-A and Node-B

To support a nested RTT, a method of calculating a distance between a node-A and a node-B based on information on the time domain information to be measured based on an RS transmitted and received by the node-A and/or the node-B. Hereinafter, a distance calculation method using a structure of the nested RTT is explained based on an example of FIG. 10. However, those skilled in the art will understand that the proposed method may be generally applied when the structural characteristics of the nested RTT are maintained.

Hereinafter, a method to obtain a propagation delay required for transmitting and receiving a reference signal between the node-A and the node-B to estimate distance information between the node-A and the node-B is proposed. In this case, those skilled in the art will understand that the result of measuring the propagation delay of the reference signal is information expressing a distance between two nodes.

In the structure of the nested RTT, a method may be used to estimate distance information between the node-A and the node-B by using an RX-TX time difference information that each node is capable of calculating based on the RS burst and the transmission/reception time of the RSs. In this case, the following transmission/reception timings may be used for the RX-TX time differences used.
From a perspective of the node-A, a time difference (hereinafter Tₐ₁) between a time when an RS transmitted by the node-B is received and a time when a first RS (hereinafter RS-B) is transmitted
From a perspective of the node-A, a time difference (hereinafter Tₐ₂) between a time when the RS-B is received and a time when a second RS on the RS burst (hereinafter RS-A2) is transmitted
From a perspective of the node-B, a time difference (hereinafter T_{b1}) between a time when the RS-A1 is received and a time when the RS-B is transmitted
From a perspective of the node-B, a time difference (hereinafter T_{b2}) between a time when the RS-A2 is received and a time when the RS-B is transmitted

When the RX-TX time difference values are used, the distance estimation method using the nested RTT may be applied differently depending on a structure of transmitting and receiving a RS burst and an RS between the node-A and the node-B (i.e. a relative order of the times when the RS burst and the RS are transmitted and received). When the nested RTT operates with the structure of CASE 1 in the example of FIG. 10, the size of the propagation delay required for transmitting and receiving a reference signal between the node-A and the node-B may be calculated using the mathematical expression 3 below. When the nested RTT operates with the structure of CASE 2 in the example of FIG. 10, the size of the propagation delay required for transmitting and receiving a reference signal between the node-A and the node-B may be calculated using the mathematical expression 4 below.

$$\hat{T} = \frac{{T}_{a 2} \times {T}_{b 1} - {T}_{a 1} \times {T}_{b 2}}{{T}_{a 1} - {T}_{a 2} + {T}_{b 1} - {T}_{b 2}} \qquad [ Equation 3 ]$$

$$\hat{T} = - \frac{{T}_{a 2} \times {T}_{b 1} - {T}_{a 1} \times {T}_{b 2}}{{T}_{a 1} - {T}_{a 2} + {T}_{b 1} - {T}_{b 2}} \qquad [ Equation 4 ]$$

In the structure of the nested RTT, a method of using other time information than the RX-TX time difference value may be considered as a method of estimating distance information, and as a specific method, transmission/reception time difference values between RSs within an RS burst may be utilized as follows.
From a perspective of the node-A, a time difference (hereinafter Tₐ₃) between times when the RS-A1 and the RS-A2 on an RS burst are transmitted
From a perspective of the node-B, a time difference (hereinafter T_{b3}) between times when the RS-A1 and the RS-A2 on an RS burst are received

When the transmission/reception time difference values between RSs within the RS burst are used, Equation 5 may be derived based on Equations 3 and 4, and regardless of the structure of the nested RTT (i.e. commonly applied to CASE1 and CASE2 in the example of FIG. 10), the size of the propagation delay required for transmitting and receiving the reference signal between the node-A and the node-B may be calculated.

$$\hat{T} = \frac{{T}_{a 2} \times {T}_{b 1} - {T}_{a 1} \times {T}_{b 2}}{{T}_{a 3} + {T}_{b 3}} \qquad [ Equation 5 ]$$

### Embodiment of Measurement Report

To support a nested RTT, a method to calculate and report measurements based on RS bursts and RS transmitted and received by the node-A and/or the node-B is proposed. The present disclosure below proposes some components to be provided in a measurement report performed in the structure of the nested RTT, and values other than those mentioned may be provided in the measurement report.

A node (hereinafter referred to as Node-L) that calculates the distance between the node-A and the node-B and/or ultimately estimates the location of the node-A or the node-B needs to be provided with measurement values measured by the node-A and the node-B as information. For example, the node-L may be an LMF based on the 3GPP NR standard, or may be a UE (including an SL UE) functioning as the node-A and the node-B. Information required by the node-L may include RX-TX time difference values required to apply Equations 3, 4, and/or 5, or transmission/reception time difference values between RSs within an RS burst. Considering this, one of the following options may be selected and used as a specific method for determining the values of the measurements reported by the node-A or the node-B in the nested RTT.

### (Option 3-1) RX-TX Time Difference

In the structure of the nested RTT, the node-A may measure values of Tₐ₁ and Tₐ₂ and report the values. The node-B may measure values of T_{b1} and T_{b2} and report the values. In this case, the node-A needs to use the same reception signal (i.e. RS transmitted by the node-B) as a reference point in a process of calculating Tₐ₁ and Tₐ₂ and the node-B may be configured to use the same transmission signal (i.e. RS transmitted by the node-B) as a reference point in a process of calculating T_{b1} and T_{b2}.

The proposed method has an advantage of being able to largely reuse an RX-TX time difference report method used in the existing RTT method, and also has an advantage of being easy to expand even when the number of RSs selected in an RS burst increases (i.e. even when the number of RX-TX time differences exceeds two).

(Option 3-2) RX-TX Time Difference+RS Time Difference within RS Burst

In the structure of the nested RTT, the node-A may be configured to measure values of Tₐ₁ and Tₐ₃ and report the values, and the node-B may be configured to measure values of T_{b1} and T_{b3} and report the values. Alternatively, the node-A may be configured to measure values of Tₐ₂ and Tₐ₃ and report the values, and the node-B may be configured to measure values of T_{b2} and T_{b3} and report the values. In this case, the node-A needs to use the same reception signal (i.e. RS transmitted by the node-B) as a reference point in a process of calculating Tₐ₁ and Tₐ₂ and the node-B may be configured to use the same transmission signal (i.e. RS transmitted by the node-B) as a reference point in a process of calculating T_{b1} and T_{b2}.

The proposed method replaces one RX-TX time difference result with a transmission/reception time difference value between RSs within an RS burst, and when a range required to express the transmission/reception time difference value between RSs within an RS burst is smaller than a range required to express the RX-TX time difference, it may be expected to have an advantageous effect in terms of reducing the signaling overhead for measurement reporting.

FIG. 11 is a diagram for explaining an operation of a first device for a nested RTT according to an embodiment. In FIG. 11, the first device may be the node-A or the node-B in FIG. 10.

Referring to FIG. 11, the first device may receive configuration information for a first type of reference signal related to positioning (A05). The configuration information for the first type of reference signal may be received via a network (e.g., BS/TRP, or positioning related server). In some embodiments, the configuration information for the first type of reference signal provided from a network may be received via the second device.

The first device may transmit the first type of reference signal to the second device multiple times based on the configuration information in a time duration including a plurality of first time resources (A10). The first device may receive the second type of reference signal related to positioning from the second device in one second time resource located after the time duration including the plurality of first time resources (A15).

As described through FIG. 10, transmission of the first type of reference signal may be performed multiple times after reception of the second type of reference signal is performed first. For example, the first device may receive the second type of reference signal related to positioning from the second device in one second time resource, and transmit the first type of reference signal to the second device multiple times based on the configuration information in a time duration including a plurality of first time resources located after the second time resource.

The reception of the second type of reference signal that is performed on the one second time resource, may be related to the multiple times of transmissions of the first type of reference signal. The time duration including the plurality of first time resources may be determined based on the repetition number for the first type of reference signal provided in the configuration information.

The multiple transmissions of the first type of reference signal and receptions of the second type of reference signal may be related to round trip time (RTT) measurement.

Reception of the one second type of reference signal, performed on the one second time resource, may be related to a plurality of RTT measurement values based on the same reception timing (Rx timing). The first device may transmit a measurement report including the plurality of RTT measurement values. The measurement report may further include information about a time interval between the plurality of first time resources.

The plurality of first time resources may be spaced apart from each other in the time domain based on the time interval.

Information about the time interval may be obtained through measurement configuration related to positioning.

The first type of reference signal may be a sounding reference signal (SRS) for positioning. The first device may be a user equipment (UE).

The second type of reference signal may be a positioning reference signal (PRS), and the second device may be at least one BS or at least one transmission and reception point (TRP).

Both the first device and the second device are UEs, and the first type of reference signal and the second type of reference signal may each be an SL reference signal.

FIG. 12 is a diagram for explaining an operation of a second device for a nested RTT according to an embodiment. In FIG. 12, the first device may be the node-B or the node-A in FIG. 10.

Referring to FIG. 12, the second device may transmit configuration information for the first type of reference signal related to positioning (B05). The configuration information for the first type of reference signal may be provided via a network (e.g., BS/TRP, or positioning related server).

The second device may receive the first type of reference signal multiple times from the second device based on the configuration information in a time duration including a plurality of first time resources (B10). The first device may transmit the second type of reference signal related to positioning to the second device in one second time resource located after the time duration including the plurality of first time resources (B15).

As described through FIG. 10, reception of the first type of reference signal may be performed multiple times after transmission of the second type of reference signal is performed first. For example, the second device may transmit the second type of reference signal related to positioning to the first device in one second time resource, and receive the first type of reference signal from the first device multiple times based on the configuration information in a time duration including a plurality of first time resources located after the second time resource.

Transmission of the second type of reference signal, performed on the one second time resource, may be related to the multiple times of receptions of the first type of reference signal. The time duration including the plurality of first time resources may be determined based on the repetition number for the first type of reference signal provided in the configuration information.

The multiple receptions of the first type of reference signal and transmissions of the second type of reference signal may be related to round trip time (RTT) measurement.

Transmission of the one second type of reference signal, performed on the one second time resource, may be related to a plurality of RTT measurement values based on the same reception timing (Rx timing). The second device may receive a measurement report including the plurality of RTT measurement values. The measurement report may further include information about a time interval between the plurality of first time resources.

The plurality of first time resources may be spaced apart from each other in the time domain based on the time interval.

Information about the time interval may be provided through measurement configuration related to positioning.

The first type of reference signal may be a sounding reference signal (SRS) for positioning. The first device may be a user equipment (UE).

The second type of reference signal may be a positioning reference signal (PRS), and the second device may be at least one BS or at least one transmission and reception point (TRP).

Both the first device and the second device are UEs, and the first type of reference signal and the second type of reference signal may each be an SL reference signal.

FIG. 13 is a diagram for explaining operations of devices in a network system for a nested RTT according to an embodiment. In FIG. 13, the first device may be a node-A or a node-B in FIG. 10, and the second device may be the node-B or the node-A in FIG. 10.

The first device may transmit a first type reference signal to the second device multiple times in a time duration including a plurality of first time resources (C05). The first device may receive the second type of reference signal related to positioning from the second device in one second time resource located after the time duration including the plurality of first time resources (C10). The reception of the second type of reference signal that is performed on the one second time resource, may be related to the multiple times of transmissions of the first type of reference signal. The time duration including the plurality of first time resources may be determined based on the repetition number for the first type of reference signal provided in the configuration information.

The multiple transmissions of the first type of reference signal and receptions of the second type of reference signal may be related to round trip time (RTT) measurement. RTT measurement is to compensate for errors caused by clock drift in a CPM of an NR, and may be either a nested RTT or double side RTT. Reception of the one second type of reference signal, performed on the one second time resource, may be related to a plurality of RTT measurement values based on the same reception timing (Rx timing).

The first device may transmit a measurement report including the plurality of RTT measurement values (C15). The measurement report may further include information about a time interval between the plurality of first time resources. The measurement report may be transmitted to the second device, but is not limited thereto. The measurement report may also be transmitted to a network server such as a BS/TRP or an LMF.

As described above, the measurement report may include an RX-TX time difference (e.g., Option 3-1) or additionally include an RS time difference within an RS burst (e.g., Option 3-2).

Based on the measurement report, a propagation delay related to a distance between the first device and the second device may be determined. The propagation delay may be determined based on at least one of Equations 3, 4 and/or 5.

FIG. 14 illustrates a communication system 1 applied to the present disclosure.

Referring to FIG. 14, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. 15 illustrates wireless devices applicable to the present disclosure.

Referring to FIG. 15, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 14.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In an embodiment of the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In an embodiment of the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 16 illustrates another example of a wireless device applied to the present disclosure. The wireless device may be implemented in various forms according to a use-case/service (refer to FIG. 14).

Referring to FIG. 16, wireless devices 100 and 200 may correspond to the wireless devices 100 and 200 of FIG. 15 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 15. For example, the transceiver(s) 114 may include the one or more transceivers 106 and 206 and/or the one or more antennas 108 and 208 of FIG. 15. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 14), the vehicles (100b-1 and 100b-2 of FIG. 14), the XR device (100c of FIG. 14), the hand-held device (100d of FIG. 14), the home appliance (100e of FIG. 14), the IoT device (100f of FIG. 14), a digital broadcast terminal, a hologram device, a public safety device, an MTC device, a medicine device, a fintech device (or a finance device), a security device, a climate/environment device, the AI server/device (400 of FIG. 14), the BSs (200 of FIG. 14), a network node, etc. The wireless device may be used in a mobile or fixed place according to a use-example/service.

In FIG. 16, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 17 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 17, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 16, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features may be implemented in a form failing to be combined with other elements or features. Moreover, it is able to implement an embodiment of the present disclosure by combining elements and/or features together in part. A sequence of operations explained for each embodiment of the present disclosure may be modified. Some configurations or features of one embodiment may be included in another embodiment or may be substituted for corresponding configurations or features of another embodiment. And, an embodiment may be configured by combining claims failing to have relation of explicit citation in the appended claims together or may be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL AVAILABILITY

The present disclosure is applicable to UEs, BSs, or other apparatuses in a wireless mobile communication system.

1. A method performed by a first device, the method comprising:
receiving configuration information for a first type of reference signal related to positioning:
transmitting the first type of reference signal to a second device multiple times based on the configuration information in a time duration including a plurality of first time resources; and
receiving, from the second device, a second type of reference signal related to positioning in one second time resource located after the time duration including the plurality of first time resources,
wherein the reception of the second type of reference signal that is performed on the one second time resource, is related to the multiple times of transmissions of the first type of reference signal, and
wherein the time duration including the plurality of first time resources is determined based on a repetition number for the first type of reference signal included in the configuration information.

2. The method of claim 1, wherein the multiple transmissions of the first type of reference signal and the reception of the second type of reference signal are related to round trip time (RTT) measurement.

3. The method of claim 1, wherein the reception of the one second type of reference signal performed on the one second time resource, is related to a plurality of round trip time (RTT) measurement values which are based on a same reception timing (Rx timing).

4. The method of claim 3, further comprising:
transmitting a measurement report including the plurality of RTT measurement values.

5. The method of claim 4, wherein the measurement report further includes information about a time interval between the plurality of first time resources.

6. The method of claim 1, wherein the plurality of first time resources are spaced apart from each other in a time domain based on a time interval.

7. The method of claim 6, wherein information about the time interval is obtained through measurement configuration related to positioning.

8. The method of claim 1, wherein the first type of reference signal is a sounding reference signal (SRS) for positioning, and the first device is a user equipment (UE).

9. The method of claim 1, wherein the second type of reference signal is a positioning reference signal (PRS), and the second device is at least one base station (BS) or at least one transmission and reception point (TRP).

10. A non-transitory processor-readable recording medium having recorded thereon a program for performing the method of claim 1.

11. A first device comprising:
a memory configured to instructions; and
a processor configured to perform operations by executing the instructions,
wherein the operations of the processor include:
receiving configuration information for a first type of reference signal related to positioning:
transmitting, to a second device, the first type of reference signal multiple times based on the configuration information in a time duration including a plurality of first time resources; and
receiving, from the second device, a second type of reference signal related to positioning in one second time resource located after the time duration including the plurality of first time resources;
wherein the reception of the second type of reference signal that is performed on the one second time resource, is related to the multiple times of transmissions of the first type of reference signal, and
wherein the time duration including the plurality of first time resources is determined based on a repetition number for the first type of reference signal included in the configuration information.

12. The first device of claim 11, wherein the first device is an application specific integrated circuit (ASIC) or a digital signal processing device.

13. The first device of claim 11, wherein the first device is a user equipment (UE), a base station (BS), or a transmission and reception point (TRP), which operates in a wireless communication system based on 3rd generation partnership (3GPP).

14. A method performed by a second device, the method comprising:
transmitting, to a first device, configuration information for a first type of reference signal related to positioning:
receiving, from the first device, the first type of reference signal multiple times based on the configuration information in a time duration including a plurality of first time resources; and
transmitting, to the first device, a second type of reference signal related to positioning in one second time resource located after the time duration including the plurality of first time resources,
wherein the transmission of the second type of reference signal that is performed on the one second time resource, is related to the multiple times of receptions of the first type of reference signal, and
wherein the time duration including the plurality of first time resources is determined based on a repetition number for the first type of reference signal included in the configuration information.

15. (canceled)

16. The first device of claim 11, wherein the second device is a user equipment (UE), a base station (BS), or a transmission and reception point (TRP).
